(19) United States
(12) Patent Application Publication
(10) Pub. No.: US 2010/0070891 A1
(43) Pub. Date: Mar. 18, 2010

(54) System and method for configuring an application via a visual map interface

(76) Inventors: William J. Creekbaum, San Mateo, CA (US); Charles L. Guerin, Morin Heights (CA)

Correspondence Address: Tina M. Lessani;Lessani & Lessani LLP, 163 Cypress Point Road, Half Bay Moon, CA, 94019, US

(21) Appl. No.: 12/378,482

(22) Filed: Feb. 13, 2009

Related U.S. Application Data
(60) Provisional application No. 61/192,541, filed on Sep. 18, 2008.

(51) Int. Cl. G06F 3/048

(52) U.S. Cl. 715/763; 715/234

(57) ABSTRACT

The present invention provides a system and method for configuring an application via a visual map interface. The method involves providing a visual map into which a user can enter configuration data for the application. The visual map includes predefined topics that correspond to configurable portions of the application, and the user enters the configuration data as subtopics to the predefined topics. The predefined topics may be defined by a programmer or system administrator for the configurable application. When the configurable application requests the configuration data, the applicable data entered into the subtopics is sent to the configurable application.

### RELATED APPLICATIONS

This application claims the benefit of U.S. Provisional Application No. 61/192,541 filed on Sep. 18, 2008 with inventors William J. Creekbaum and Charles L. Guerin and titled “System and Method for Configuring an Application via a Visual Map Interface,” the contents of which are incorporated by reference as if fully disclosed herein

### BACKGROUND OF THE INVENTION

1. Field of the Invention

This invention relates generally to visual mapping systems, and, more particularly, to configuring an application via a visual map interface.

2. Description of the Background Art

Applications used by enterprises often have to be configured for the particular needs of that enterprise. For example, the data that appears in a particular dialog box in an application, or the choices available in a drop-down menu in the application, may be configured to the specific needs of the enterprise.

Configuring an application often requires an application administrator, or other IT personal, to enter configuration data for the application (e.g., entering the data that will appear in a dialog box, or the choices that appear in a drop-down menu). The configuration data defines the specifics of how the application will appear and interact with a user. This configuration data is a type of “metadata” used by the application.

Conventionally, configuration data is stored in a relational database, text-based configuration file, or other custom method. Entering configuration data usually requires the assistance of an IT professional who is familiar with database languages, such as SQL, or other programming languages. This can be a hassle for an application administrator who must coordinate with an enterprise's IT group in order to make a change to an application's configuration. Consequently, it is desirable to provide a simpler way for an application administrator to configure an application that does not require the administrator to be familiar with a database language or programming techniques.

### SUMMARY OF THE INVENTION

The present invention provides a system and method for configuring an application via a visual map interface. The method comprises providing a visual map into which a user can enter configuration data for the application. The visual map includes predefined topics that correspond to configurable portions of the application, and the user enters the configuration data as subtopics to the predefined topics. The predefined topics may be defined by a programmer or system administrator for the configurable application.

After the user enters the configuration data into the visual map and saves the map, a visual mapping application stores the map data, including the configuration data. The map data is stored in a way such that hierarchical relationships in the map are preserved. (i.e., relationships between parent topics and subtopics are preserved).

In one embodiment, when a configured application needs the configuration data, the configured application makes a call for configuration data corresponding to one or more of the predefined topics in the visual map. In response, the visual mapping application retrieves the configuration data corresponding to the predefined topic(s). Specifically, it retrieves the subtopic data entered by the user and associated with the predefined topic(s). The visual mapping application then sends the retrieved configuration data to the configured application.

### BRIEF DESCRIPTION OF THE DRAWINGS

FIG. 1 is an example of a mind map.

FIG. 2 is a flowchart that illustrates a method for configuring an application via a visual map interface.

FIGS. 3 is an example of a resulting map in a configurable visual mapping application.

FIG. 4 is an example of a visual map with configuration data.

FIG. 5 is an example of a dialog box associated with a configurable map part.

FIG. 6 is an example of another dialog box associated with a configurable map part.

FIG. 7 is an example of a visual mapping system in which the present invention can be implemented.

### DETAILED DESCRIPTION OF THE PREFERRED EMBODIMENTS

The present invention provides a system and method for configuring an application via a visual map interface. A visual map is a diagram that represents ideas and/or information in topics. Examples of visual maps are mind maps, topic maps, semantic networks, and concept maps. Visual maps are used to help people generate, classify, and/or organize ideas and information and to see such ideas and information in a hierarchical, visual layout.

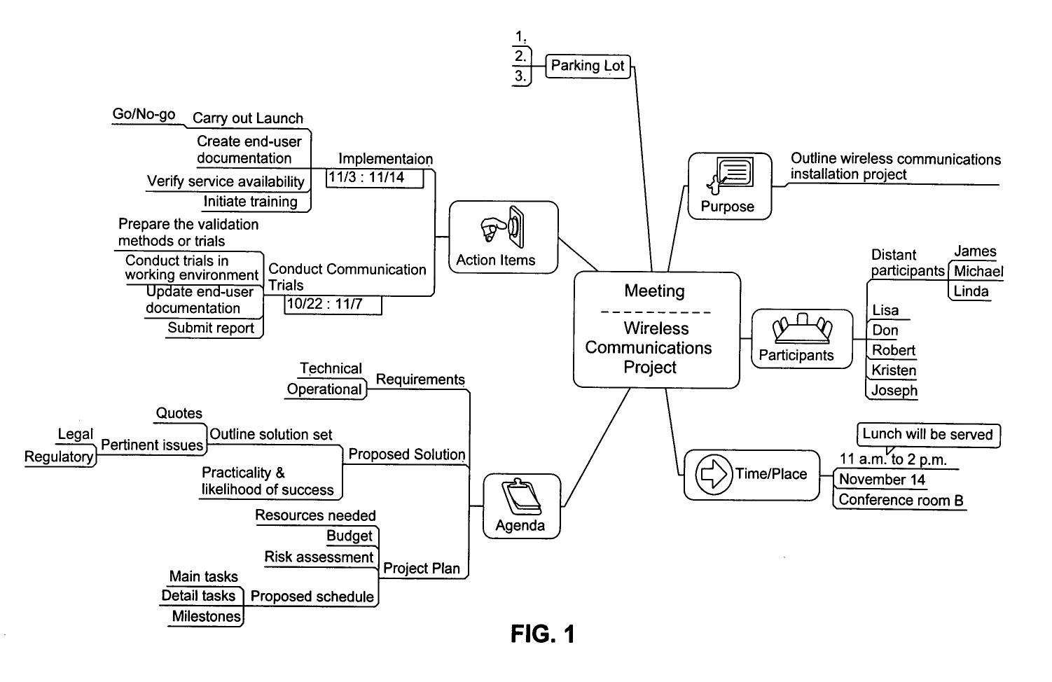

FIG. 1 is an example of a visual map for information related to a wireless communication project meeting. The visual map in FIG. 1 is a mind map. Mind maps are made up of hierarchically-arranged topics. The main topics in FIG. 1 are “Action Items”, “Purpose”, “Agenda”, “Time Place”, “Participants”, and “Purpose.” Each of these topics has subtopics. For instance, “Implementation” is a subtopic for “Action Items,” and “Carry out Launch” is a subtopic of “Implementation.”

There are software programs that enable people to easily create visual maps. MINDJET LLC's MINDMANAGER® software is an example of such software.

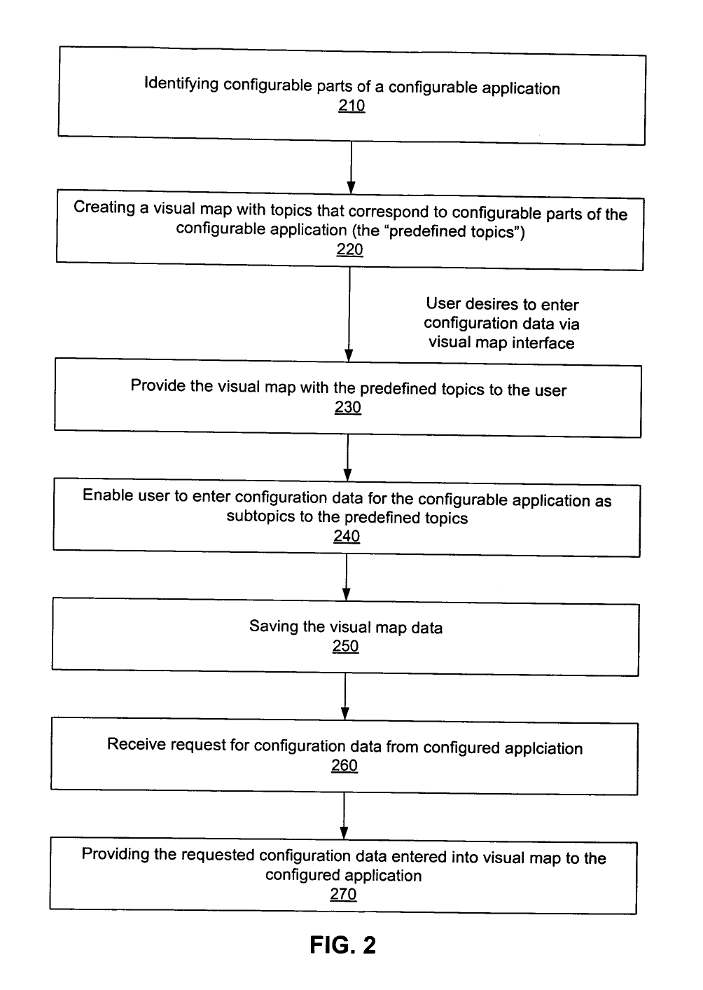

FIG. 2 illustrates a method for configuring an application via a visual map interface. In one embodiment, this method is implemented by a visual mapping application, such as MINDJET's MINDMANAGER or MINDJET CONNECT software. In the preferred embodiment, the visual mapping application includes a client application (either desktop or web) and a server application. The configured application can be any type of application. An enterprise application used by a business is an example of the type of application that can be configured via a visual map interface.

The method comprises identifying configurable parts of a configurable application (step 210) and creating a visual map with topics that correspond to configurable parts of the configurable application (the “predefined topics”) (step 220). The predefined topics may be defined by a programmer or system administrator for the configurable application.

When a user desires to configure the configurable application, the user opens, in the visual mapping application, the visual map with the predefined topics (step 230). The visual mapping application enables the user to enter configuration data for the configurable application as subtopics to the predefined topics (step 240).

As discussed above, data for configuring an application is conventionally entered into a database table. In one embodiment, the predefined topics in the present invention would correspond to column names in a database table, and the sub-topics in which configuration data is entered would correspond to the values in the tables.

After the user enters the configuration data into subtopics, the visual mapping application saves the map data (step 250). When the configured application launches, or otherwise needs the configuration data, it sends a request for the configuration data to the visual mapping application (step 260). In response, the visual mapping application retrieves the visual map data and sends the configured application the requested configuration data entered into the visual map (step 270).

In one embodiment, when a configured application needs the configuration data, it makes a call to the visual mapping application in a similar way it would make a call to a database. The call may be made via a communication API for the visual mapping application.

In one embodiment, the configurable applicable loads the configuration data in an in-memory object model so that the data can be quickly accessed via programmatic means. Hierarchical relationships in the map are preserved in the object model. In other words, the data relationship between a parent topic and a child topic (i.e., subtopic) is preserved in the object model. In one embodiment, the object model is implemented in XML.

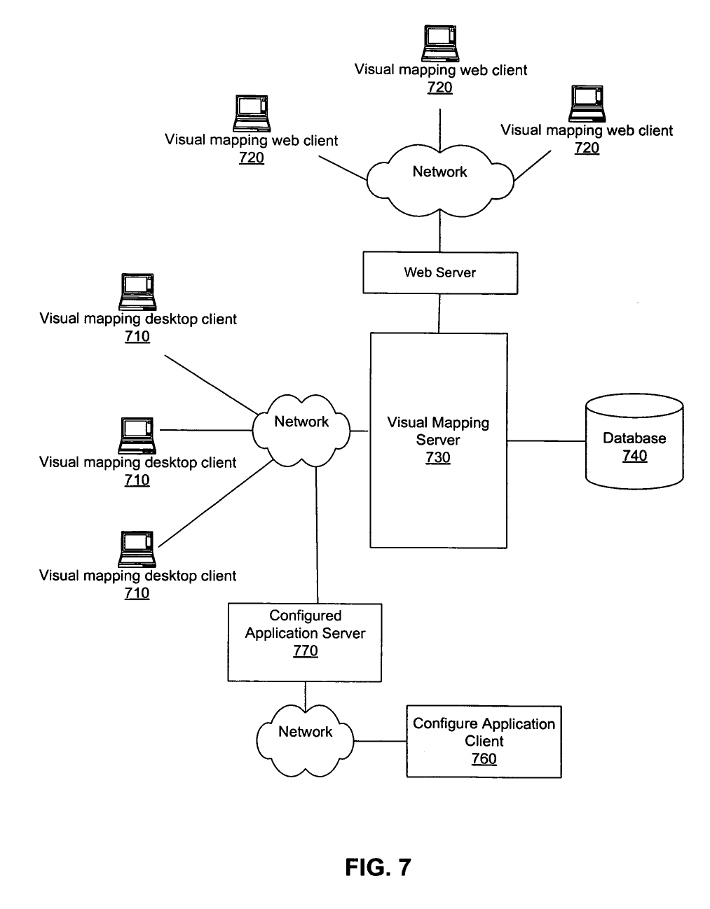

FIG. 7 illustrates an example of a system 700 in which the present invention can be implemented. System 700 is only an example, and the invention is not limited to system 700.

In system 700, a user can enter configuration data into a visual map from a visual mapping desktop client 710 or a visual mapping web client 720. These visual mapping clients 710, 720 are served by a visual mapping server 730. MINDJET's MINDJET CONNECT is an example of a visual mapping server application. After a user enters configuration data into a visual map, the visual mapping client (710 or 720) sends the map data to the visual mapping server, which stores the data in a file system or a database 740. A visual map can be stored as a file, or it the topics in a map can be stored in individually in a database, as described in U.S. patent application Ser. No. 12/001,533 titled “System and Method for Enabling a User to Search and Retrieve Individual Topics in a Visual Mapping System,” which was filed on Dec. 12, 2007 and which is incorporated by reference as if fully disclosed herein.

Configured client application 760 represents an application that has been configured via a visual map, and is served by an application server 770. An application server 770 and the visual mapping server 730 communicate with each other via a communications API. When the configured client application 760 launches or otherwise needs the configuration data, the application server 770 requests the configuration data from the visual mapping server 730.

The visual mapping server 730 retrieves the map with the configuration data from the database 740 and sends the configuration data to the application server 770, which then provides the configuration data to the configured client application 760. In one embodiment, the visual mapping server 730 provides the configuration data to the application server 770 in the form of an XML file that is organized hierarchically in the same manner as the visual map with the configuration data.

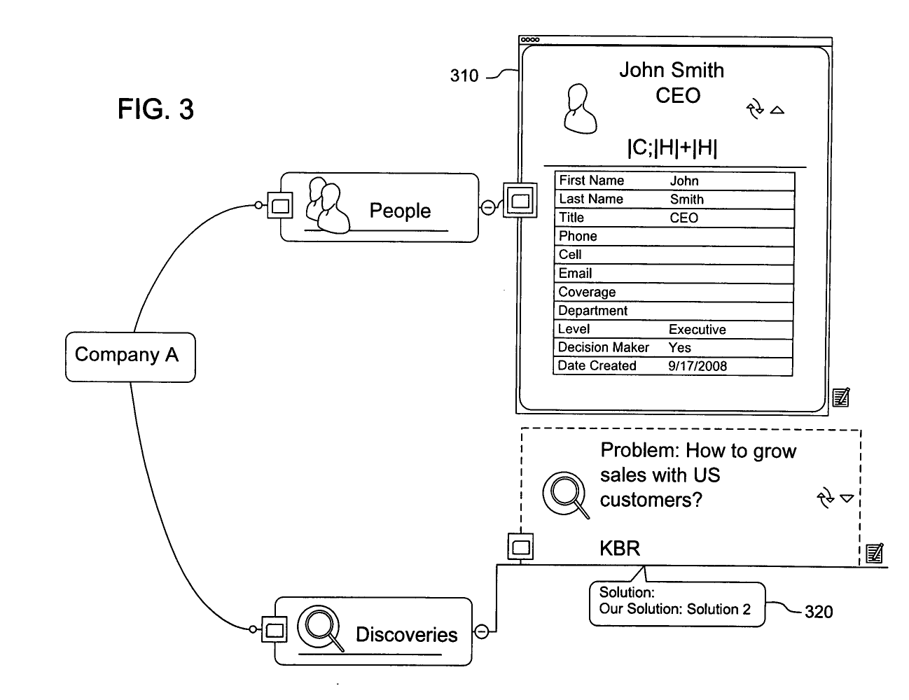

FIGS. 3-6 illustrate an example of using a visual map interface to configure an application. In the example, the application configured is also a visual mapping application, but this invention is in no way limited to configuring a visual mapping application. The invention can be used to configure any type of application capable of making a communication call to retrieve configuration data.

In this example, an application administrator uses a visual map (referred to herein as the “configuration data map”) to configure the “map parts” in FIG. 3 titled “People” 310 and “Solution” 320. As used herein, a “map part” is a topic with predefined behavior designed for a certain type of data. In the present example, the “People” map part 310 displays data about a contact at a company, such as the contact's phone number, email, department, level, etc. A “Solution” map part 320 displays data about a particular solution to a problem statement.

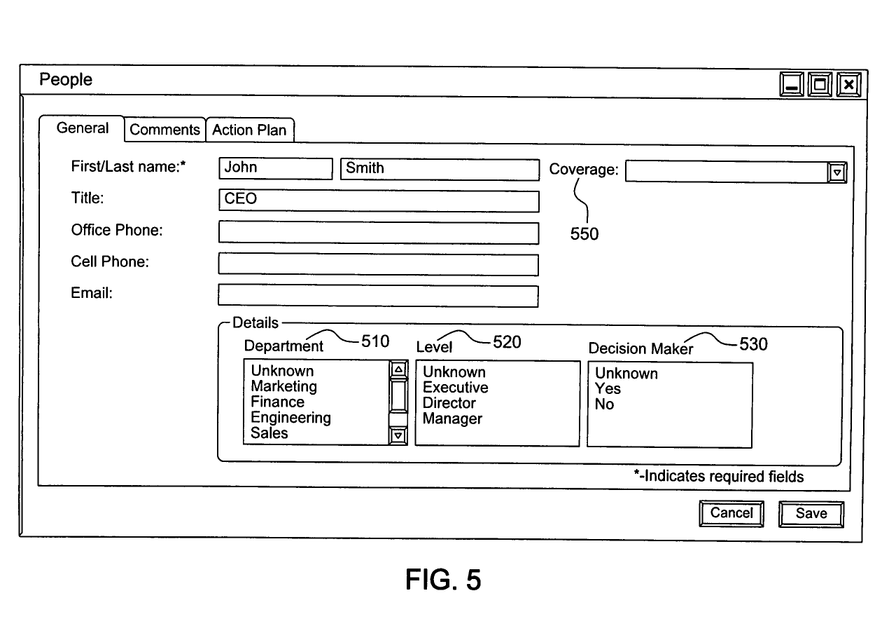

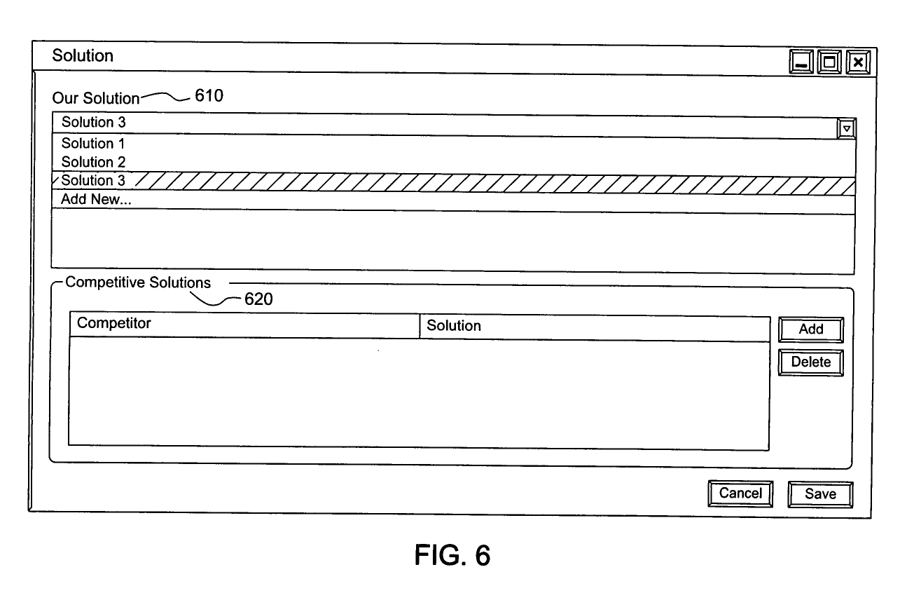

When a user creates a “People” or “Solution” map part, a dialog box (e.g., FIGS. 5 and 6, respectively) appears in which a user enters data for the map part. An application administrator can configure these map parts by defining the choices presented to the user in these dialog boxes.

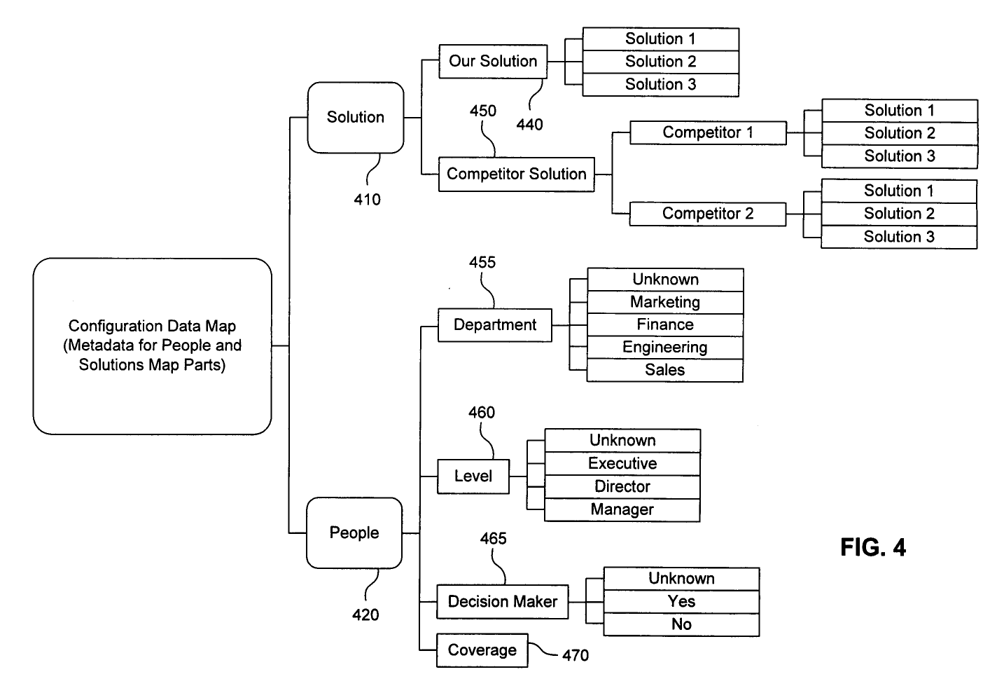

The configuration data map for this example is illustrated in FIG. 4. When a user creates a “People” 310 or “Solution” 320 map part, the configured visual mapping application requests the configuration dated entered into the visual map displayed in FIG. 4. The requested configuration data is then sent to the configuring visual mapping application, and such data is used to display the dialog boxes shown in FIGS. 5 and 6.

In the configuration data map illustrated in FIG. 4, the topics “Solution” 410 and “People” 420 are predefined by a programmer and correspond to the “Solution” and “People” map parts 310, 320 shown in FIG. 3. Similarly, the next level of topics 440-470 are also predefined and correspond to fields in the dialog boxes associated with the “Solution” and “People” map parts 310, 320. Specifically, the topics “Our Solution” 440 and “Competitor Solution” 450 correspond to fields 610, 620 in the dialog box (FIG. 6) that appears when a user creates a “Solution” map part 320. The predefined topics “Department” 455, “Level” 460, “Decision Maker” 465, and “Coverage” 470 in FIG. 4 corresponds to fields 510-550 in the dialog box (FIG. 5) for the “People” map part 310.

An application administrator (or other user) is able to configure these aforementioned fields by creating subtopics to these predefined topics. These subtopics correspond to values associated with these fields in the dialog boxes. In the present example, an application administrator has entered “Solution 1,” “Solution 2,” and “Solution 3” as subtopics to the predefined topic “Our Solution” 440 in FIG. 4. Consequently, the values corresponding to the field “Our Solution” 610 shown in FIG. 6 are “Solution 1,” “Solution 2,” and “Solution 3.” Similarly, via the map in FIG. 4, the application administrator had defined the list of values corresponding to the field “Department” 510 shown in FIG. 5 as “Unknown,” “Marketing,” “Finance” “Engineering” and “Sales.” Similarly, the values for the fields “Level” 520 and “Decision Maker” 530 shown in FIG. 5 correspond to the subtopics to topics 460 and 465, respectively, in the map in FIG. 4.

As will be understood by those familiar with the art, the invention may be embodied in other specific forms without departing from the spirit or essential characteristics thereof. Accordingly, the above disclosure of the present invention is intended to be illustrative and not limiting of the invention.

1. A method for configuring a configurable application via a visual map interface, the method comprising:
providing a visual map into which a user can enter configuration data for the configurable application, wherein the visual map includes one or more predefined topics that correspond to configurable portions of the configurable application and wherein the user is able to enter the configuration data as subtopics to the predefined topics;
storing data in the visual map;
receiving a request from the configurable application for configuration data; and
providing configuration data entered into the visual map to the configurable application.

2. The method of claim 1, wherein the visual map is a mind map.

3. The method of claim 1, wherein the visual map is a topic map.

4. The method of claim 1, wherein the visual map data is stored in a map file.

5. The method of claim 1, wherein the visual map data is stored in a structured XML file.

6. The method of claim 1, wherein storing the visual map data comprises storing the topics in the visual map individually in a database.

7. The method of claim 1, wherein the configuration data requested by the configurable application corresponds to one or more of the predefined topics, and wherein retrieving the requested configuration data comprises retrieving subtopic data entered by the user and associated with such predefined topic(s).

8. The method of claim 1, wherein the configurable application is a visual mapping application.

9. The method of claim 1, wherein the configurable application is an enterprise application used by a business.

10. The method of claim 1, wherein the predefined topics correspond to fields in a dialog box in the configurable application.

11. The method of claim 10, wherein the configuration data entered by the user into subtopics of the predefined topics are the values associated with such fields.

12. A computer program embodied on a computer-readable medium and comprising code, that, when executed by a computer, enables the computer to perform the following method:
providing a visual map into which a user can enter configuration data for the configurable application, wherein the visual map includes one or more predefined topics that correspond to configurable portions of the configurable application and wherein the user is able to enter the configuration data as subtopics to the predefined topics;
storing data in the visual map;
receiving a request from the configurable application for configuration data; and
providing configuration data entered into the visual map to the configurable application.

13. The computer program of claim 12, wherein the visual map is a mind map.

14. The computer program of claim 12, wherein the visual map is a topic map.

15. The computer program of claim 12, wherein the visual map data is stored in a map file.

16. The computer program of claim 12, wherein the visual map data is stored in a structured XML file.

17. The computer program of claim 12, wherein storing the visual map data comprises storing the topics in the visual map individually in a database.

18. The computer program of claim 12, wherein the configuration data requested by the configurable application corresponds to one or more of the predefined topics, and wherein retrieving the requested configuration data comprises retrieving subtopic data entered by the user and associated with such predefined topic(s).

19. The computer program of claim 12, wherein the configurable application is a visual mapping application.

20. The computer program of claim 12, wherein the configurable application is an enterprise application used by a business.

21. The computer program of claim 12, wherein the predefined topics correspond to fields in a dialog box in the configurable application.

22. The computer program of claim 21, wherein the configuration data entered by the user into subtopics of the predefined topics are the values associated with such fields.
